(19) United States
(12) Patent Application Publication
(10) Pub. No.: US 2025/0279837 A1
(43) Pub. Date: Sep. 4, 2025

(54) ITERATIVE EQUALIZATION IN VARYING CHANNEL CONDITIONS

(71) Applicant: MaxLinear, Inc., Carlsbad, CA (US)

(72) Inventor: Sridhar Ramesh, Carlsbad, CA (US)

(73) Assignee: MaxLinear, Inc., Carlsbad, CA (US)

(21) Appl. No.: 19/067,736

(22) Filed: Feb. 28, 2025

Related U.S. Application Data
(60) Provisional application No. 63/560,465, filed on Mar. 1, 2024.

(51) Int. Cl. H04B 17/29; H04B 17/309

(52) U.S. Cl. CPC H04B 17/29; H04B 17/346

(57) ABSTRACT

A method may include testing, at a receiver, a full equalizer to determine a performance parameter. The method may include setting, at a receiver, a target performance parameter based on the performance parameter. The method may include performing, at the receiver, a first equalization operation based on the target performance parameter. The method may include setting, at the receiver, a deferred decision region based on the target performance parameter and the first equalization operation. The method may include performing, at the receiver, a second equalization operation based on the target performance parameter.

### RELATED APPLICATION

This application claims the benefit of U.S. Provisional Application No. 63/560,465, filed Mar. 1, 2024, the disclosure of which is incorporated herein by reference in its entirety.

The examples discussed in the present disclosure are related to digital receivers and associated methods for equalization.

### BACKGROUND

Unless otherwise indicated herein, the materials described herein are not prior art to the claims in the present application and are not admitted to be prior art by inclusion in this section.

Digital communication systems map discrete symbols which may be modulated and transmitted as signals. The communication channel may impart noise, non-linear characteristics, and dispersion on the signal as the signal travels through the communication medium. The receiver may attempt to recover the signal embedded within the noise and other impairments. Methods for recovering the signal while balancing power constraints and performance constraints may be useful.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A method may include testing, at a receiver, a full equalizer to determine a performance parameter. The method may include setting, at a receiver, a target performance parameter based on the performance parameter. The method may include performing, at the receiver, a first equalization operation based on the target performance parameter. The method may include setting, at the receiver, a deferred decision region based on the target performance parameter and the first equalization operation. The method may include performing, at the receiver, a second equalization operation based on the target performance parameter.

A digital receiver may include a processing device. The processing device may test, at the digital receiver, a full equalizer to determine a performance parameter. The processing device may set, at the digital receiver, a target performance parameter based on the performance parameter. The processing device may perform, at the digital receiver, a first equalization operation based on the target performance parameter. The processing device may set, at the digital receiver, a deferred decision region based on the target performance parameter and the first equalization operation. The processing device may perform, at the digital receiver, a second equalization operation based on the target performance parameter.

A computer-readable storage medium may include computer executable instructions that, when executed by one or more processors, may cause a digital receiver to test, at the digital receiver, a full equalizer to determine a performance parameter. The computer executable instructions, when executed by one or more processors, may cause a digital receiver to set, at the digital receiver, a target performance parameter based on the performance parameter. The computer executable instructions, when executed by one or more processors, may cause a digital receiver to perform, at the digital receiver, a first equalization operation based on the target performance parameter. The computer executable instructions, when executed by one or more processors, may cause a digital receiver to set, at the digital receiver, a deferred decision region based on the target performance parameter and the first equalization operation. The computer executable instructions, when executed by one or more processors, may cause a digital receiver to perform, at the digital receiver, a second equalization operation based on the target performance parameter.

Techniques for iterative equalization in varying channel conditions may use the information obtained from symbols falling within a hard decision region after a first processing operation (e.g., a first equalization operation) to assist in resolving symbols not landing with the hard decision region following the first processing operation. This technique may be used in various non-limiting examples such as in decision feedback equalization, maximum likelihood sequence estimation, or the like.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates example graphs for digital communication systems.

FIG. 2 illustrates example graphs for receiver signal processing.

FIG. 3 illustrates an example graph for signal processing complexity.

FIG. 4 illustrates example graphs for signal processing complexity reduction.

FIG. 5 illustrates an example flow diagram for iterative equalization.

FIG. 6A illustrates an example graph for iterative equalization.

FIG. 6B illustrates an example graph for iterative equalization.

FIG. 6C illustrates an example graph for iterative equalization.

FIG. 7 illustrates a block diagram of an example system configured to perform iterative equalization.

FIG. 8 illustrates an example process flow for iterative equalization.

FIG. 9 illustrates a diagrammatic representation of a machine in the example form of a computing device within which a set of instructions, for causing the machine to perform any one or more of the methods discussed herein, may be executed.

FIG. 10 illustrates example graphs for iterative equalization.

FIG. 11 illustrates an example graph for iterative equalization.

FIG. 12 illustrates an example graph for iterative equalization.

FIG. 13 illustrates an example graph for iterative equalization.

FIG. 14 illustrates an example graph for iterative equalization.

### DESCRIPTION

Receiver signal processing may involve equalization which may compensate for channel dispersion and other impairments. A digital transmitter may map a signal to transmitting symbols and transmit the signal over a communication medium. Reconstructing the signal may be performed by mapping the signal to the transmitted symbols. A simple slicer may be used by computing a minimum distance to a nominal symbol level. Maximum likelihood sequence detection may act on un-equalized or partially equalized signals.

Receiver signal processing complexity is based on the complexity of equalization. Therefore, reducing the complexity of equalization may reduce the complexity of receiver signal processing. Various tradeoffs may be made including trading complexity for receiver performance (e.g., detection probability). Partial equalization may be used to reduce complexity while sacrificing performance (e.g., detection probability). Consequently, a method for reducing complexity without sacrificing performance by using partial equalization may be useful.

Performing partial equalization and iterative equalization may reduce complexity without sacrificing performance. A digital receiver may include a processing device. The processing device may: test, at the digital receiver, a full equalizer to determine a performance parameter; set, at the digital receiver, a target performance parameter based on the performance parameter; perform, at the digital receiver, a first equalization operation based on the target performance parameter; set, at the digital receiver, a deferred decision region based on the target performance parameter and the first equalization operation; and set, at the digital receiver, a second equalization operation based on the target performance parameter.

In addition, information that is received by processing symbols that fall within a hard decision region may be used to resolve symbols that do not fall within the hard decision region (i.e., that fall within the deferred decision region). Some use cases may include e.g., decision feedback equalization, maximum likelihood sequence estimation, belief propagation, and/or low density parity check (LDPC) coding. In these cases, partial information (e.g., information obtained from the hard decision region) may be used to determine information that does not fall within a hard decision region. Alternatively or in addition, information that falls within a hard decision region may be used without determining information that does not fall within a hard decision region. Omitting operations that do not fall within a hard decision region may reduce processing power relative to a baseline.

These techniques for iterative equalization may be applied to numerous techniques beyond equalization, detection, and signal reconstruction. For example, these techniques may be used in classification, decoding, and quantization. In the case of classification of images and/or videos, a first pass on a low resolution image may be facilitated (e.g., the base layers with layered encoding). A conditional second pass may be facilitated if the first pass classification is not successful. In the case of decoding, iterative decoding with early termination may be provided. For example decoding may use a low density parity check decoder or a Viterbi decoder. In the case of quantization of signals/voltages, a first pass of the signals/voltages may be facilitated and then a conditional second pass may be provided if the first-pass is not successful.

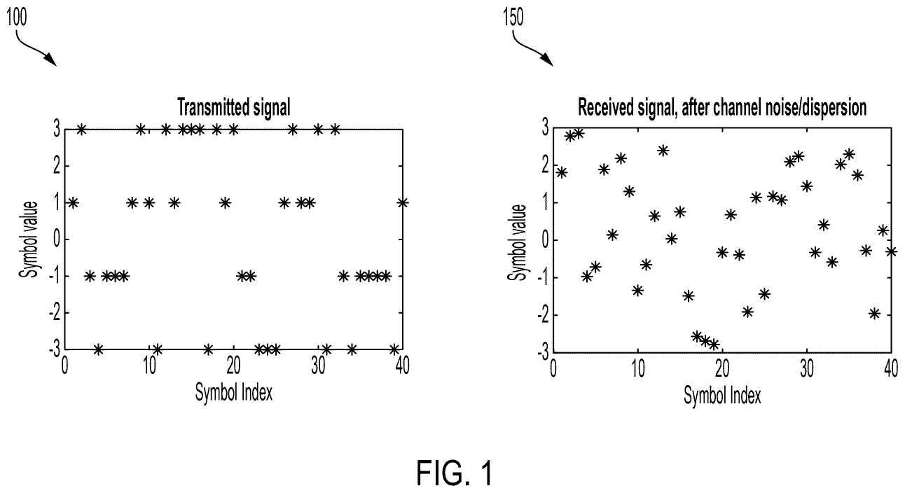

FIG. 1 illustrates example graphs for digital communication systems. Information may be mapped to discrete “symbols”, then modulated and transmitted as a signal. A graph 100 of the transmitted signal has a symbol index (e.g., ranging from 0 to 40) that is mapped to a symbol value (e.g., having a symbol value of −3, or −1, or 1, or 3). The communication channel may impart noise, non-linearity, and/or dispersion on the signal. A graph 150 of the received signal after channel noise and/or dispersion shows a symbol index (e.g., ranging from 0 to 40) and a symbol value (e.g., having a symbol value ranging between −3 and 3). The four discrete symbol values of the graph 100 have been replaced by additional values in the graph 150. The receiver may attempt to recover the signal embedded within noise and other impairments, e.g., using Pulse Amplitude Modulation in intensity modulation direct detection (IMDD)-optical communication systems.

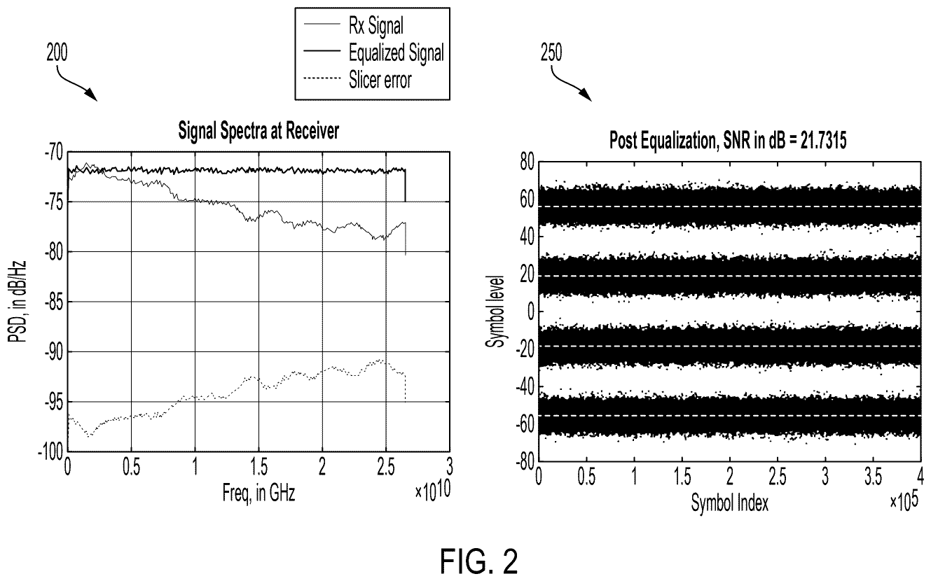

FIG. 2 illustrates example graphs 200, 250 for receiver signal processing. Equalization may compensate for channel dispersion. In graph 200, the power spectral density (PSD) in decibels per hertz (dB/Hz) is plotted against the frequency in gigahertz (GHz) to show the signal spectra at the receiver of various signals and errors. In graph 200, a received (Rx) signal is shown, an equalized signal is shown, and a slicer error is shown. In graph 250, the symbol level is plotted as a function of the symbol index in a post equalization graph in which the signal-to-noise ratio (SNR) in dB is 21.7315. Detection may be used to map the signal to the transmitted symbols. This may be accomplished using a simple slicer (e.g., using the minimum distance to nominal symbol level) or Maximum Likelihood Sequence Detection on un-equalized or partially equalized signals.

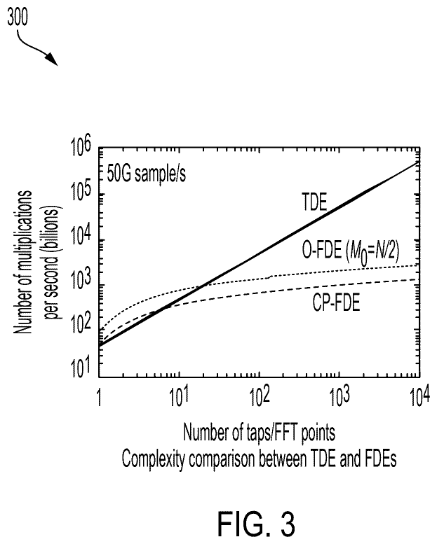

FIG. 3 illustrates an example graph 300 for signal processing complexity. In this complexity comparison between time domain equalization (TDE) and frequency domain equalization (FDE), the number of multiplications per second (in billions) was plotted as a function of the number of taps/fast Fourier transform (FFE) points. There were 50 G samples per second. Three different equalizers were used. First, a TDE was shown to have a nearly linear relationship between number of taps/fast Fourier transform (FFT) points and the number of multiplications per second. Second, an overlapping frequency domain equalizer (O-FDE) having an M₀ of N/2, was shown to have a curve that flattens out. Third, a cyclic prefix frequency domain equalizer (CP-FDE) was shown to have a curve that flattens out faster than the curve for the O-FDE.

Receiver signal processing complexity may be dominated by equalization. Different types of equalizers may be used including a linear equalizer (FFE) full programmable finite impulse response (FIR) filter having a complexity of O(R×Nt×Wd×Wc) in which Rate=R, Number of taps=Nt, bit width of data=Wd, and bit width of coefficients=Wc. A time domain equalizer may be used having a complexity of time domain equalizer (TDE)−channel delay spread×signal bandwidth. A frequency domain equalizer may be used having a complexity of signal bandwidth×log (channel delay spread). For the frequency domain equalizer, the overlap FFT method for FDE may be used to determine the number of taps (e.g., FFT size α overlap size=number of taps).

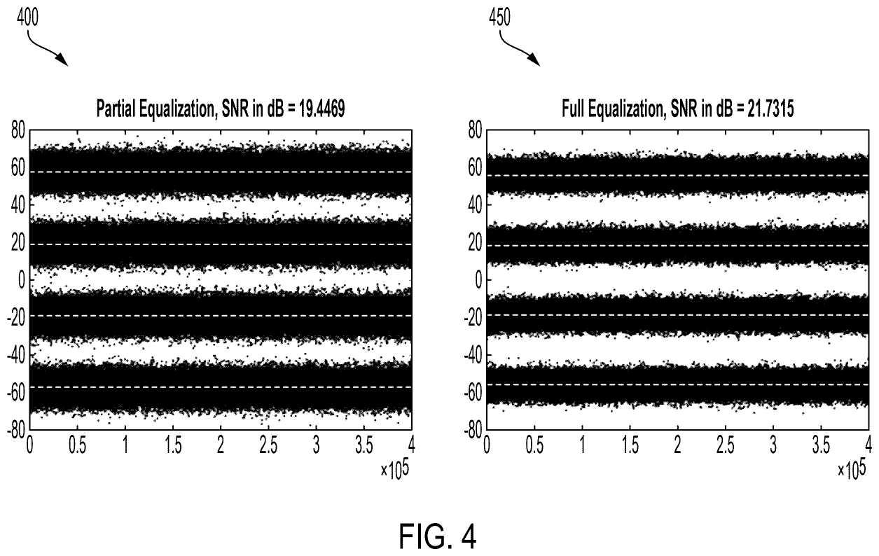

FIG. 4 illustrates example graphs 400, 450 for signal processing complexity reduction. These graphs 400, 450 show graphs 400 for partial equalization and graphs 450 for full equalization. For graphs 400, 450 symbol level is plotted as a function of symbol index. Complexity may be traded for receiver performance (detection probability). Partial equalization may leave residual inter-symbol interference (ISI), which may degrade detection probability. However, fewer operations may be used at the receiver, so power may be saved. For partial equalization, the SNR in dB may be 19.4469. For full equalization, the SNR in dB may be 21.7315.

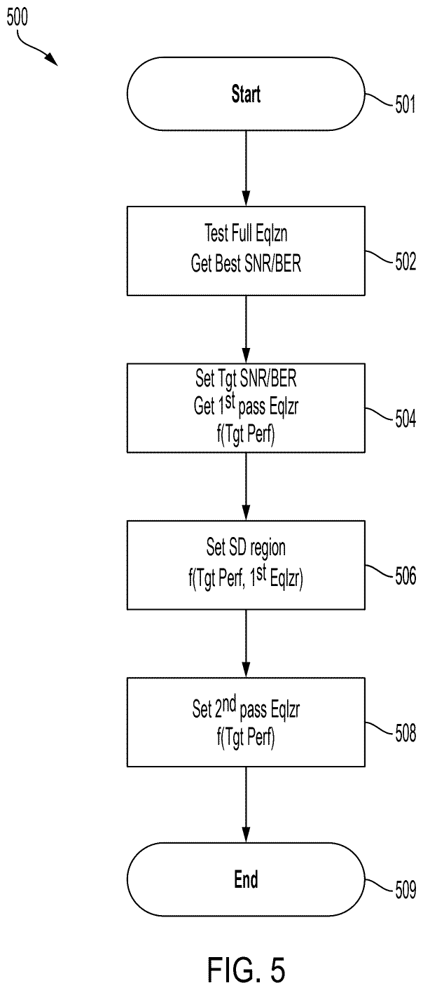

Channel conditions (e.g., noise, ISI) may evolve and methods may be used in response. As illustrated in FIG. 5, a method 500 may start 501 and may include testing, at a receiver, a full equalizer to determine a performance parameter, as shown in operation 502. The method may further include setting, at a receiver, a target performance parameter based on the performance parameter and performing, at the receiver, a first equalization operation based on the target performance parameter, as shown in operation 504. The method may further include setting, at the receiver, a deferred decision region based on the target performance parameter and the first equalization operation, as shown in operation 506. The method may further include performing, at the receiver, a second equalization operation based on the target performance parameter, as shown in operation 508. This loop from operation 502 to operation 508 may run when channel conditions (e.g., noise, ISI) are evolving. The loop may end 509 when channel conditions (e.g., noise, ISI) are not evolving.

One or more of the first pass equalizer, the deferred decision region (e.g., soft decision (SD) region), or the second pass equalizer may be set as a function of the target performance parameter. The target performance parameter may be one or more of the signal-to-noise ratio (SNR) or a bit error rate (BER). The target performance parameter may be set as a function of the achievable SNR or BER. That is, the achievable SNR or BER may be determined using a full equalizer, then the target SNR or BER may be set based on this achievable SNR or BER.

The target SNR/BER may be used to get the first-pass equalizer, which may be a partial equalizer. The deferred decision region may be set based on the target SNR/BER and the first pass equalizer. The 2^{nd} pass equalizer may be used for the deferred decision region. The first pass equalizer may be a single tap frequency domain equalizer. The second pass equalizer may be one or more of a residual feedforward equalizer, a decision feedback equalizer, or maximum likelihood sequence detection. The second pass equalizer may use a simple threshold. One or more of the first pass equalizer or the second pass equalizer may be one or more of time domain equalizer or a frequency domain equalizer.

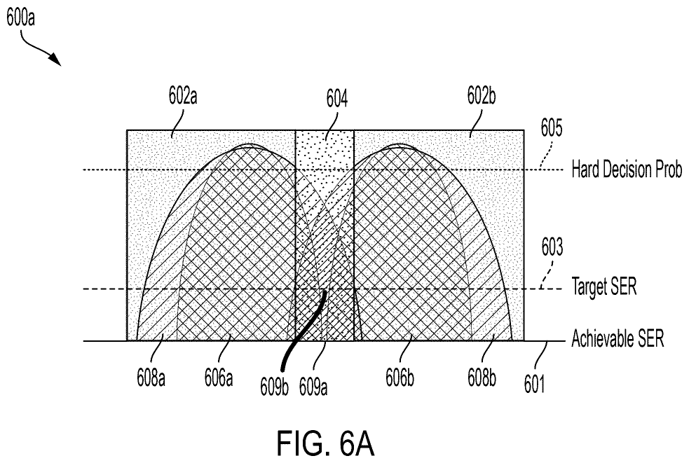

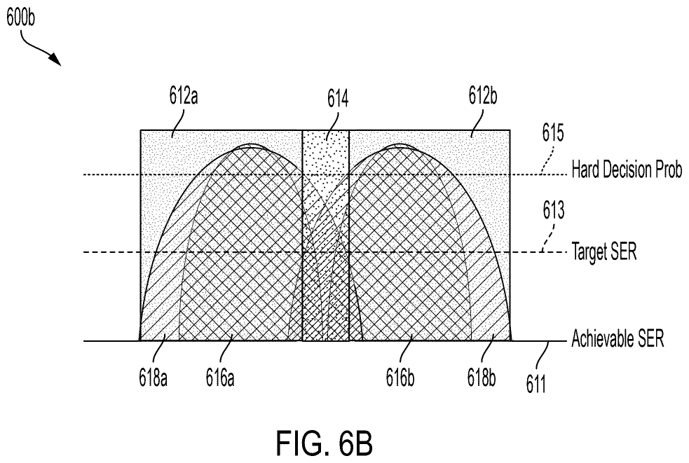

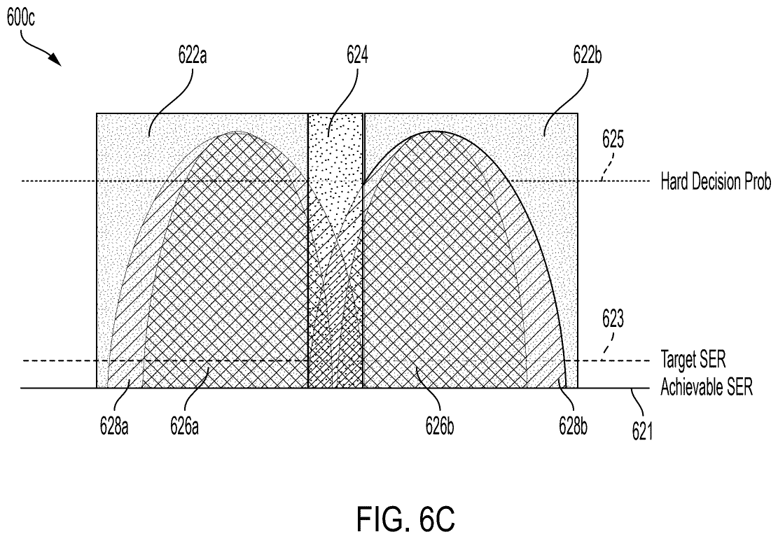

As illustrated in FIG. 6A, the graph 600a may have four regions: a hard decision (HD) region 602a, 602b, a deferred decision (DD) region 604, a full equalization histogram region 606a, 606b, and a partial equalization histogram region 608a, 608b. The full equalization histogram regions 606a, 606b may intersect with the achievable symbol error rate (SER) 601 at four points and may have a gap 609a between the inner points of intersection. When a target SER 603 is used instead of the achievable SER 601, the full histogram regions 606a, 606b may intersect with the target SER 603 at four points and may have a gap 609b between the inner points of intersection. The gap 609b between the two inner points of intersection for the target SER 603 may be a larger gap than the gap 609a between the two inner points of intersection for the achievable SER 601.

For the partial equalization histograms 608a, 608b there may not be a gap between the inner points of intersection at the achievable SER 601 or at the target SER 603. For the partial equalization histograms 608a, 608b, there may be a region of overlap between the left partial equalization histogram 608a and the right partial equalization histogram 608b. When partial equalization is used, the hard decision threshold may be set so that the left partial equalization histogram 608a does not intersect with the right partial equalization histogram 608b. By preventing intersection between the left partial equalization histogram 608a and the right partial equalization histogram 608b, the different symbols associated with the different partial equalization histograms 608a, 608b may be detected. That is, the hard decision region 602a, 602b may have a first component hard decision region 602a that covers the partial equalization histogram region on the left and a second component hard decision region 602b that covers the partial equalization histogram region on the right. For the region between hard decision region on the left (e.g., first component hard decision region 602a) and the hard decision region on the right (e.g., second component hard decision region 602b), this region may be the deferred decision region 604.

When moving from the full equalization histograms 606a, 606b to the partial equalization histograms 608a, 608b performance and power differences may occur. That is, moderate performance reduction may occur (e.g., SER about 2× greater than the baseline amount in which the full equalization histograms 606a, 606b are used) and moderate power savings may occur (e.g., a reduction in power of 40% compared to the baseline amount in which the full equalization histograms 606a, 606b are used). In this example, the hard decision probability 605 may be about 95% and the first pass equalizer inter-symbol interference may be 1/SNR.

In this example, the full equalizer may be tested to determine the achievable SER 601. The target SER 603 may be set based on the achievable SER 601. The first pass equalizer may be performed as a function of the target SER 603. The deferred decision region 604 may be set as a function of the target SER 603 and the first pass equalizer. The second pass equalizer may be set as a function of the target SER 603. Therefore, the target SER may be selected to set one or more of first pass equalizer, a deferred decision region, or a second pass equalizer.

As illustrated in FIG. 6B, in the graph 600b the target SER 613 may be raised relative to the achievable SER 611 (when compared to FIG. 6A). The full equalization histograms 616a, 616b and the partial equalization histograms 618a, 618b may be set similar to FIG. 6A. The hard decision region 612a, 612b may be increased (when compared to FIG. 6A) and the deferred decision region 614 may be decreased (when compared to FIG. 6A). Lower performance may occur (e.g., SER about 5× greater than the baseline amount) and moderate power savings may occur (e.g., a reduction in power of 60% compared to the baseline amount). In this example, the hard decision probability 615 may be increased to about 98% and the first pass equalizer inter-symbol interference may be 1/SNR.

As illustrated in FIG. 6C, in the graph 600c the target SER 623 may be lowered relative to the achievable SER 621 (when compared to FIG. 6A). The full equalization histograms 626a, 626b and the partial equalization histograms 628a, 628b may be set similar to FIG. 6A. The hard decision region 622a, 622b may be narrowed (when compared to FIG. 6A) and the deferred decision region 624 may be increased (when compared to FIG. 6A). Performance reduction may be modest (e.g., SER about 1.2× greater than the baseline amount) and moderate power savings may occur (e.g., a reduction in power compared to a baseline amount of about 20%). In this example, the hard decision probability 625 may be about 97% and the first pass equalizer inter-symbol interference may be 0.25/SNR.

Deferred decision may be implemented in decision feedback equalization, ii) maximum likelihood sequence estimation, (iii) belief propagation and/or (iv) low density parity check (LDPC) coding. In these cases, information that falls within a hard decision region may be used to determine information that falls within a deferred decision region. In some cases, the partial information obtained from determining information that falls within a hard decision region may be adequate for the particular use case. As a result, the amount of processing may be reduced relative to a baseline and the performance (e.g., effective number of bits) may be maintained.

In some cases, iterative equalization may be applied independently of other techniques (e.g., deferred precision, deferred resolution). In other cases, iterative equalization may be applied in conjunction with other techniques (e.g., deferred precision, deferred resolution).

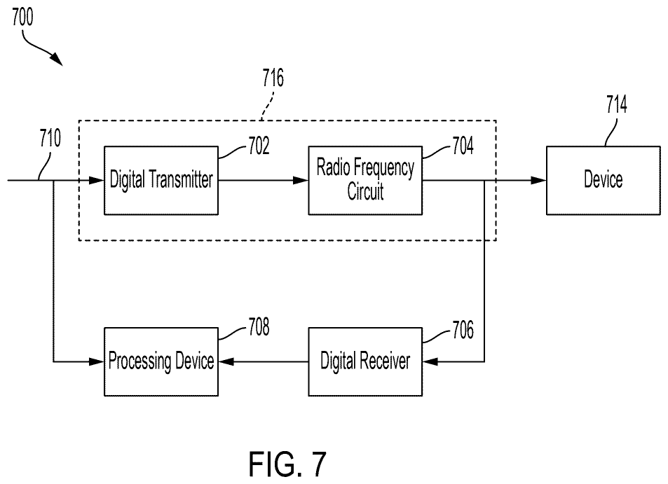

FIG. 7 illustrates a block diagram of an example communication system 700 configured for iterative equalization, in accordance with at least one example described in the present disclosure. The communication system 700 may include a digital transmitter 702, a radio frequency circuit 704, a device 714, a digital receiver 706, and a processing device 708. The digital transmitter 702 and the processing device 708 may be configured to receive a baseband signal via connection 710. A transceiver 716 may comprise the digital transmitter 702 and the radio frequency circuit 704.

In some examples, the communication system 700 may include a system of devices that may be configured to communicate with one another via a wired or wireline connection. For example, a wired connection in the communication system 700 may include one or more Ethernet cables, one or more fiber-optic cables, and/or other similar wired communication mediums. Alternatively, or additionally, the communication system 700 may include a system of devices that may be configured to communicate via one or more wireless connections. For example, the communication system 700 may include one or more devices configured to transmit and/or receive radio waves, microwaves, ultrasonic waves, optical waves, electromagnetic induction, and/or similar wireless communications. Alternatively, or additionally, the communication system 700 may include combinations of wireless and/or wired connections. In these and other examples, the communication system 700 may include one or more devices that may be configured to obtain a baseband signal, perform one or more operations to the baseband signal to generate a modified baseband signal, and transmit the modified baseband signal, such as to one or more loads.

In some examples, the communication system 700 may include one or more communication channels that may communicatively couple systems and/or devices included in the communication system 700. For example, the transceiver 716 may be communicatively coupled to the device 714.

In some examples, the transceiver 716 may be configured to obtain a baseband signal. For example, as described herein, the transceiver 716 may be configured to generate a baseband signal and/or receive a baseband signal from another device. In some examples, the transceiver 716 may be configured to transmit the baseband signal. For example, upon obtaining the baseband signal, the transceiver 716 may be configured to transmit the baseband signal to a separate device, such as the device 714. Alternatively, or additionally, the transceiver 716 may be configured to modify, condition, and/or transform the baseband signal in advance of transmitting the baseband signal. For example, the transceiver 716 may include a quadrature up-converter and/or a digital to analog converter (DAC) that may be configured to modify the baseband signal. Alternatively, or additionally, the transceiver 716 may include a direct radio frequency (RF) sampling converter that may be configured to modify the baseband signal.

In some examples, the digital transmitter 702 may be configured to obtain a baseband signal via connection 710. In some examples, the digital transmitter 702 may be configured to up-convert the baseband signal. For example, the digital transmitter 702 may include a quadrature up-converter to apply to the baseband signal. In some examples, the digital transmitter 702 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 702.

In some examples, the transceiver 716 may include one or more subcomponents that may be used in preparing the baseband signal and/or transmitting the baseband signal. For example, the transceiver 716 may include an RF front end (e.g., in a wireless environment) which may include a power amplifier (PA), a digital transmitter (e.g., 702), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 704) of the transceiver 716 may be synchronized with the resource controller via the S-plane device, which may contribute to high-accuracy timing with respect to a reference clock.

In some examples, the transceiver 716 may be configured to obtain the baseband signal for transmission. For example, the transceiver 716 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 716 may be configured to generate a baseband signal for transmission. In these and other examples, the transceiver 716 may be configured to transmit the baseband signal to another device, such as the device 714.

In some examples, the transceiver 716 may be configured to receive a transmission from the transceiver 716. For example, the transceiver 716 may be configured to transmit a baseband signal to the device 714.

In some examples, the radio frequency circuit 704 may be configured to transmit the digital signal received from the digital transmitter 702. In some examples, the radio frequency circuit 704 may be configured to transmit the digital signal to the device 714 and/or the digital receiver 706. In some examples, the digital receiver 706 may be configured to receive a digital signal from the RF circuit and/or send a digital signal to the processing device 708.

In some examples, the processing device 708 may be a standalone device or system, as illustrated. Alternatively, or additionally, the processing device 708 may be a component of another device and/or system. For example, in some examples, the processing device 708 may be included in the transceiver 716. In instances in which the processing device 708 is a standalone device or system, the processing device 708 may be configured to communicate with additional devices and/or systems remote from the processing device 708, such as the transceiver 716 and/or the device 714. For example, the processing device 708 may be configured to send and/or receive transmissions from the transceiver 716 and/or the device 714. In some examples, the processing device 708 may be combined with other elements of the communication system 700.

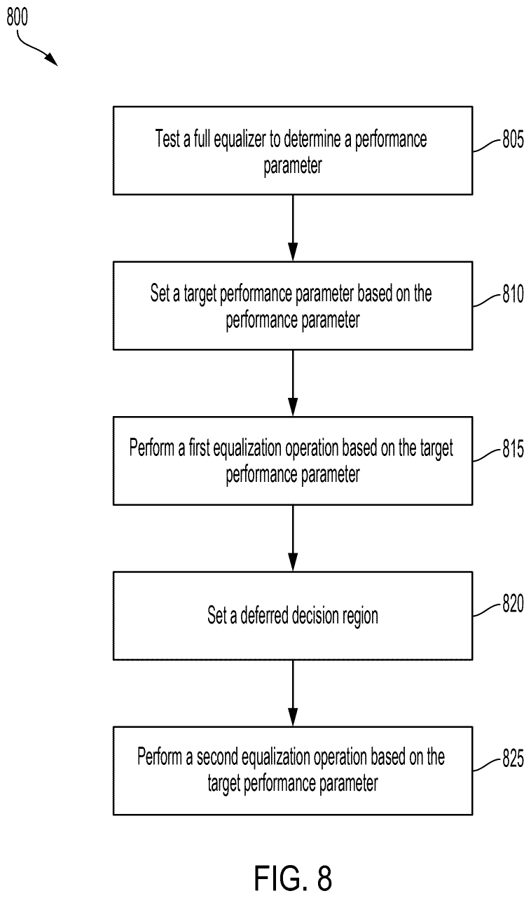

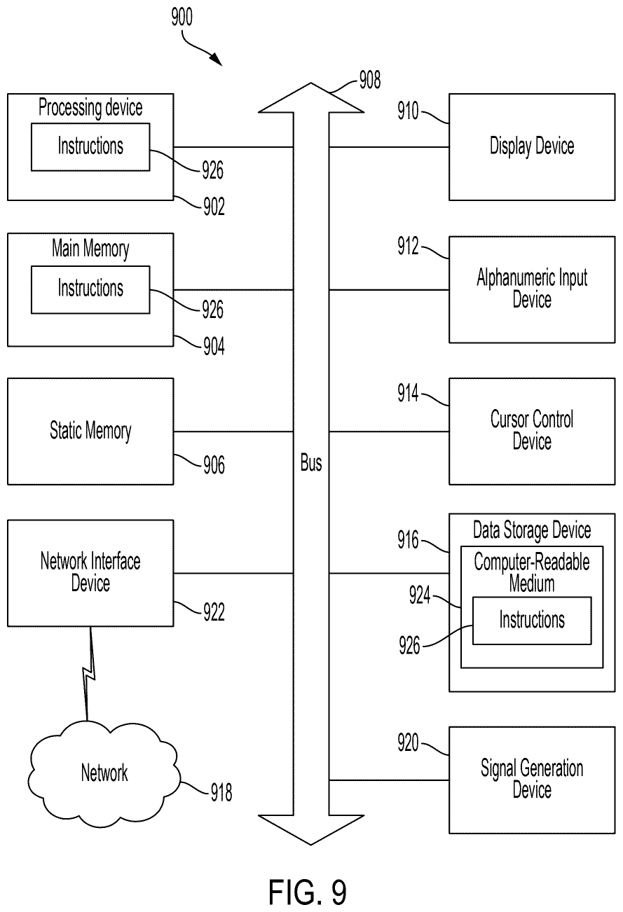

FIG. 8 illustrates a process flow of an example method 800 of iterative equalization, in accordance with at least one example described in the present disclosure. The method 800 may be arranged in accordance with at least one example described in the present disclosure. The method 800 may be performed by processing logic that may include hardware (circuitry, dedicated logic, etc.), software (such as is run on a computer system or a dedicated machine), or a combination of both, which processing logic may be included in the processor (e.g., the processing device 902 of FIG. 9), the communication system 700 of FIG. 7, or another device, combination of devices, or systems.

The method 800 may begin at block 805 where the processing logic may test a full equalizer to determine a performance parameter. At block 810, the processing logic may set a target performance parameter based on the performance parameter. At block 815, the processing logic may perform a first equalization operation based on the target performance parameter. At block 820, the processing logic may set a deferred decision region. At block 825, the processing logic may perform a second equalization operation based on the target performance parameter.

Modifications, additions, or omissions may be made to the method 800 without departing from the scope of the present disclosure. For example, in some examples, the method 800 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 9 illustrates a diagrammatic representation of a machine in the example form of a computing device 900 within which a set of instructions, for causing the machine to perform any one or more of the methods discussed herein, may be executed. The computing device 900 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 900 includes a processing device 902, a main memory 904 (e.g., read-only memory (ROM), flash memory, dynamic random access memory (DRAM) such as synchronous DRAM (SDRAM)), a static memory 906 (e.g., flash memory, static random access memory (SRAM)) and a data storage device 916, which communicate with each other via a bus 908.

Processing device 902 represents one or more general-purpose processing devices such as a microprocessor, central processing unit, or the like. More particularly, the processing device 902 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also include one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein.

The computing device 900 may further include a network interface device 922 which may communicate with a network 918. The computing device 900 also may include a display device 910 (e.g., a liquid crystal display (LCD) or a cathode ray tube (CRT)), an alphanumeric input device 912 (e.g., a keyboard), a cursor control device 914 (e.g., a mouse) and a signal generation device 920 (e.g., a speaker). In at least one example, the display device 910, the alphanumeric input device 912, and the cursor control device 914 may be combined into a single component or device (e.g., an LCD touch screen).

The data storage device 916 may include a computer-readable storage medium 924 on which is stored one or more sets of instructions 926 embodying any one or more of the methods or functions described herein. The instructions 926 may also reside, completely or at least partially, within the main memory 904 and/or within the processing device 902 during execution thereof by the computing device 900, the main memory 904 and the processing device 902 also constituting computer-readable media. The instructions may further be transmitted or received over a network 918 via the network interface device 922.

While the computer-readable storage medium 924 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to examples of the present disclosure.

### Example 1: Summary of Power Vs. Performance Analysis

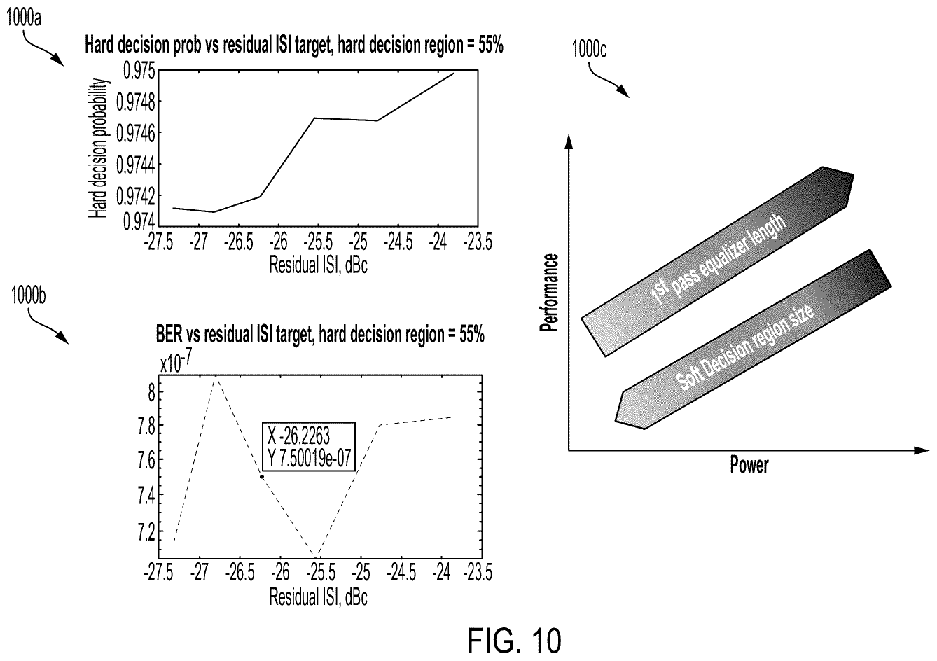

FIG. 10 illustrates example graphs 1000a, 1000b, 1000c for iterative equalization.

One graph 1000a shows the hard decision probability as a function of the residual ISI target in decibels relative to the carrier (dBc). The hard decision region is 55%. The hard decision probability increases as the residual ISI increases.

Another graph 1000b shows the BER as a function of the residual ISI target in dBc. The hard decision region is 55%. The BER has a peak at around −26.8 residual ISI. The BER reaches a trough at around −25.5 residual ISI. The BER increases between about −25.5 to about −24.7 residual ISI before leveling off after about −24.7 residual ISI.

Another graph 1000c summarizes that as the power increases, the performance increases with respect to the first pass equalizer length. Further, as the soft decision region size decreases, the power decreases and the performance decreases.

### Example 2: Simulation Results

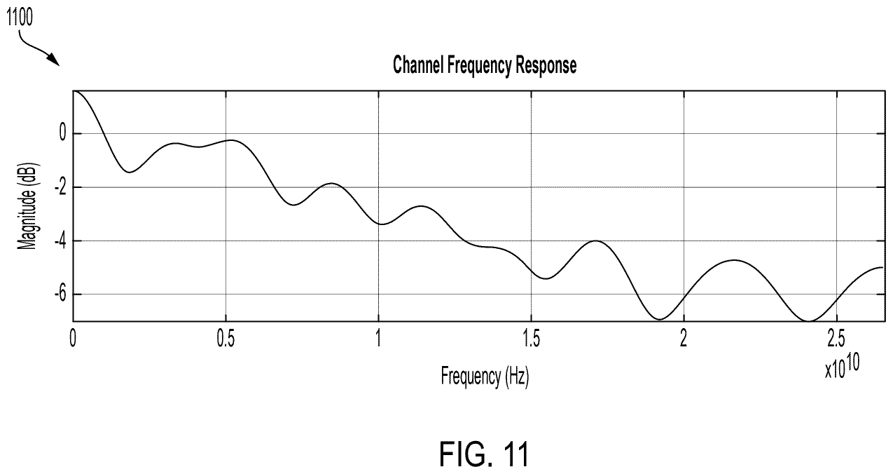

FIG. 11 illustrates an example graph 1100 for iterative equalization. An example graph 1100 is shown here, involving a channel with ˜6 dB droop at Nyquist. Long reflections beyond 10 unit intervals (UI) from main tap were present. FFE taps saw distinct clusters around the main tap and beyond 10 UI. Main pulse equalization may be captured in the partial FFE and the long delay taps may be captured in the second iteration decision feedback equalizer (DFE). Complexity of the partial FFE is ˜44% of the full FFE.

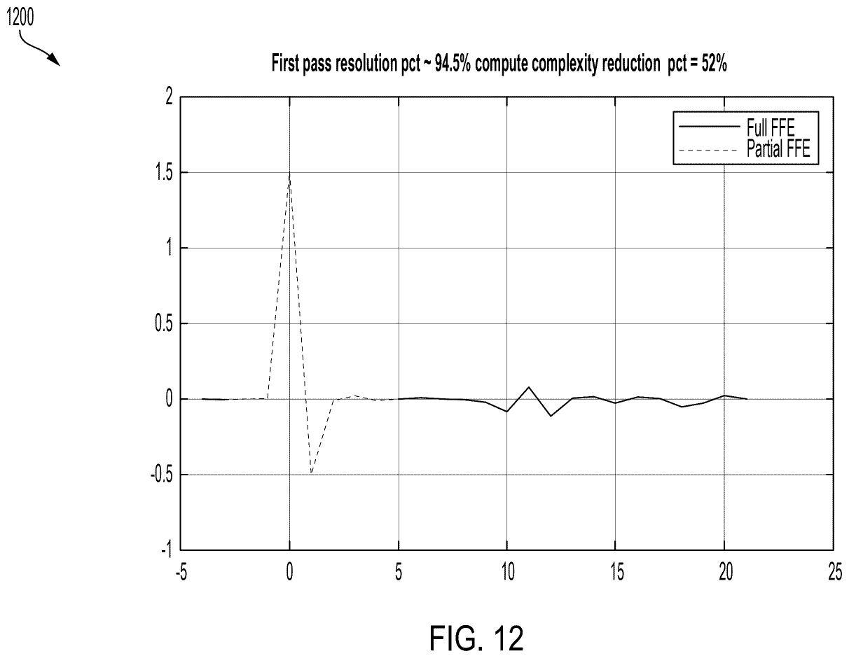

Further, as illustrated in FIG. 12 in graph 1200, after setting the first pass hard decision region to 55% of the slicer region for each inner pulse amplitude modulation (PAM) level, about 94.5% of symbols were resolved in the first iteration, leaving 5.5% symbols for the second pass. Overall power saving was ˜52%. BER using iterative approach was 1.8e-7, an increase of ˜2.5× vs 7e-8 when using single pass FFE. BER performance may be traded off for power savings by changing some system parameters such as: (1) reducing the hard decision region for first iteration; and/or (2) increasing the number of taps (or reduce residual ISI threshold) for the first iteration.

When determining target performance, a partial equalizer was selected such that residual ISI+noise satisfied the target performance. The solution space narrowed as performance targets rose or channel quality degraded.

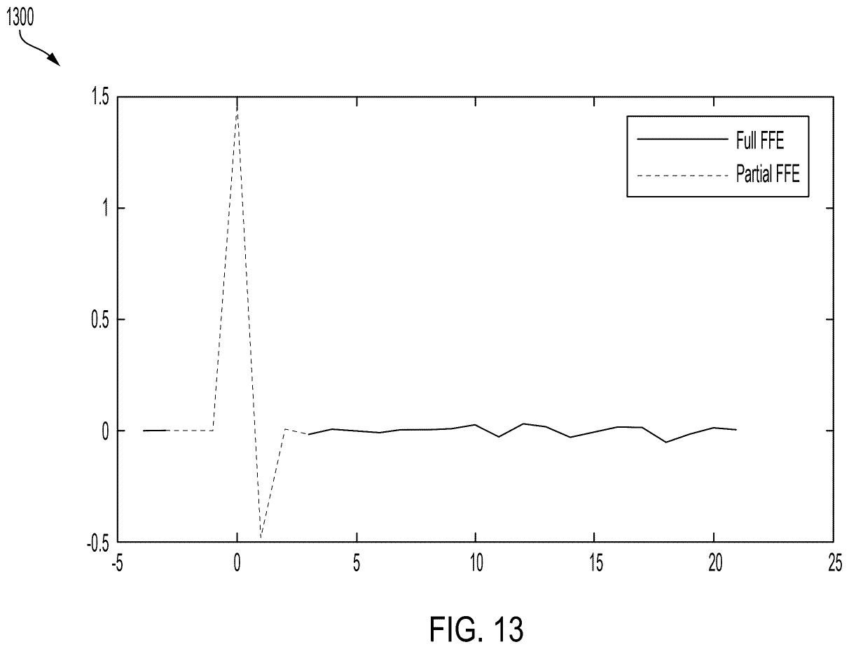

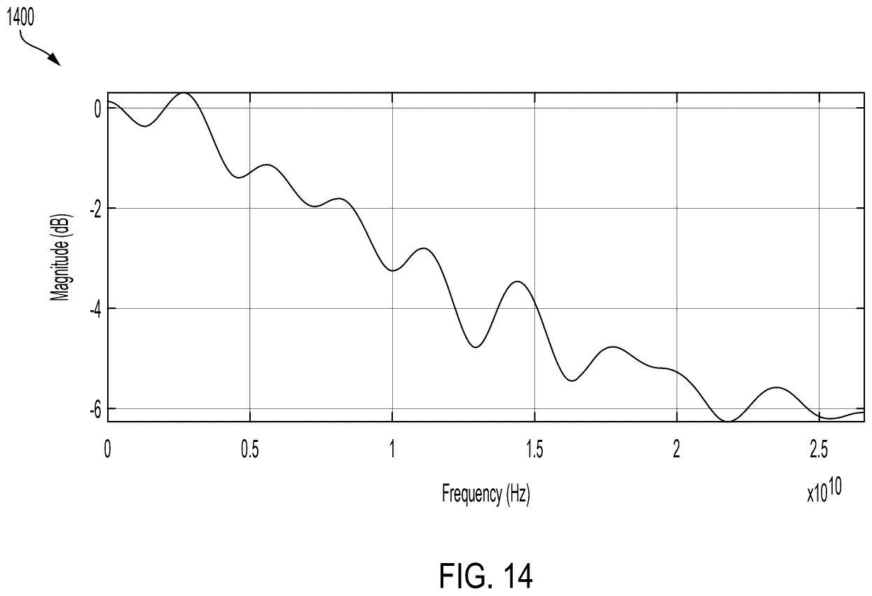

FIGS. 13 and 14 illustrate example graphs 1300, 1400 for iterative equalization. FIG. 14 shows the channel with a ˜6 dB droop at Nyquist. FIG. 13 shows full FFE and partial FFE achieved BER of 3.4e-8, while 99% of hard decisions occur in the first iteration. Power saving of the iterative equalizer was ˜56%.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A method comprising:
testing, at a receiver, a full equalizer to determine a performance parameter;
setting, at a receiver, a target performance parameter based on the performance parameter;
performing, at the receiver, a first equalization operation based on the target performance parameter;
setting, at the receiver, a deferred decision region based on the target performance parameter and the first equalization operation; and
performing, at the receiver, a second equalization operation based on the target performance parameter.

2. The method of claim 1, further comprising performing, at the receiver, the first equalization operation using a single tap frequency domain equalizer.

3. The method of claim 1, further comprising performing, at the receiver, the second equalization operation using one or more of a residual feedforward equalizer, a decision feedback equalizer, or maximum likelihood sequence detection.

4. The method of claim 1, further comprising performing, at the receiver, the second equalization operation using a simple threshold.

5. The method of claim 1, further comprising performing, at the receiver, one or more of the first equalization operation or the second equalization operation using one or more of time domain equalizer or a frequency domain equalizer.

6. The method of claim 1, wherein the performance parameter comprises one or more of a signal to noise ratio (SNR) or a bit error rate (BER).

7. The method of claim 1, further comprising detecting, at the receiver, a change in a channel condition comprising one or more of noise or inter-symbol interference (ISI).

8. A digital receiver, comprising:
a processing device operable to:
test, at the digital receiver, a full equalizer to determine a performance parameter;
set, at the digital receiver, a target performance parameter based on the performance parameter;
perform, at the digital receiver, a first equalization operation based on the target performance parameter;
set, at the digital receiver, a deferred decision region based on the target performance parameter and the first equalization operation; and
perform, at the digital receiver, a second equalization operation based on the target performance parameter.

9. The digital receiver of claim 8, wherein the processing device is further operable to:
perform, at the digital receiver, the first equalization operation using a single tap frequency domain equalizer.

10. The digital receiver of claim 8, wherein the processing device is further operable to:
perform, at the receiver, the second equalization operation using one or more of a residual feedforward equalizer, a decision feedback equalizer, or maximum likelihood sequence detection.

11. The digital receiver of claim 8, wherein the processing device is further operable to:
perform, at the receiver, the second equalization operation using a simple threshold.

12. The digital receiver of claim 8, wherein the processing device is further operable to:
perform, at the receiver, one or more of the first equalization operation or the second equalization operation using one or more of time domain equalizer or a frequency domain equalizer.

13. The digital receiver of claim 8, wherein the performance parameter comprises one or more of a signal to noise ratio (SNR) or a bit error rate (BER).

14. The digital receiver of claim 8, wherein the processing device is further operable to:
detect, at the receiver, a change in a channel condition comprising one or more of noise or inter-symbol interference (ISI).

15. A computer-readable storage medium including computer executable instructions that, when executed by one or more processors, cause a digital receiver to:
test, at the digital receiver, a full equalizer to determine a performance parameter;
set, at the digital receiver, a target performance parameter based on the performance parameter;
perform, at the digital receiver, a first equalization operation based on the target performance parameter;
set, at the digital receiver, a deferred decision region based on the target performance parameter and the first equalization operation; and
perform, at the digital receiver, a second equalization operation based on the target performance parameter.

16. The computer-readable storage medium of claim 15, wherein the instructions, when executed by the one or more processors, further cause the digital receiver to:
perform, at the digital receiver, the first equalization operation using a single tap frequency domain equalizer.

17. The computer-readable storage medium of claim 15, wherein the instructions, when executed by the one or more processors, further cause the digital receiver to:
perform, at the receiver, the second equalization operation using one or more of a residual feedforward equalizer, a decision feedback equalizer, or maximum likelihood sequence detection.

18. The computer-readable storage medium of claim 15, wherein the instructions, when executed by the one or more processors, further cause the digital receiver to:
perform, at the receiver, the second equalization operation using a simple threshold.

19. The computer-readable storage medium of claim 15, wherein the instructions, when executed by the one or more processors, further cause the digital receiver to:
perform, at the receiver, one or more of the first equalization operation or the second equalization operation using one or more of time domain equalizer or a frequency domain equalizer.

20. The computer-readable storage medium of claim 15, wherein the instructions, when executed by the one or more processors, further cause the digital receiver to:
detect, at the receiver, a change in a channel condition comprising one or more of noise or inter-symbol interference (ISI).
